(19) United States
(12) Patent Application Publication
(10) Pub. No.: US 2023/0331993 A1
(43) Pub. Date: Oct. 19, 2023

(54) USE OF AN AGENT FOR PRIMING SILICON SURFACES

(71) Applicant: FEXSIL GMBH, Goch (DE)

(72) Inventor: Joerg NASS, Goch (DE)

(21) Appl. No.: 18/144,219

(22) Filed: May 7, 2023

Related U.S. Application Data
(63) Continuation of application No. PCT/EP2022/050012, filed on Jan. 3, 2022.

(30) Foreign Application Priority Data
Jan. 6, 2021 (DE) DE102021100113.7

(51) Int. Cl. C09D 5/00; C09D 133/08; C09D 175/04; C09D 109/06

(52) U.S. Cl. CPC C09D 5/002; C09D 133/08; C09D 175/04; C09D 109/06

(57) ABSTRACT

An agent for priming silicon surfaces, wherein the agent is an emulsion including at least the following components: a catalyst configured to vulcanize rubber mixes, an organic solvent or thinner, a fine particle solid material configured as a thickener and adhesion enhancer, and a varnish paint forming a carrier substance.

### RELATED APPLICATIONS

This application is a continuation of International patent application PCT/EP2022/050012 filed on Jan. 3, 2022 claiming priority from German patent application DE 10 2021 100 113.7 filed on Jan. 6, 2021, both of which are incorporated in their entirety by this reference.

### FIELD OF THE INVENTION

The invention relates to a use of an agent for priming silicon surfaces.

### BACKGROUND OF THE INVENTION

Silicon surfaces are not paintable without using the agent according to the invention.

Contrary to the invention the Euroteam company offers gap strips that are used for priming (DE 20 2015 006 906 U1). The gap strips are not made from silicone, but from polyurethane. Besides the fact that polyurethane is quite paintable the gap strips produced by the Euroteam company are configured for taping, e.g., on concrete, stone etc., but not for a subsequent paint application.

These products are not comparable in any way nor perform with the instant invention. In the application and the field of operation are not even in related fields. Silicone gaps namely are existing construction gaps at windows, doors and glazing including bathroom installations and engineering applications in vehicles and machinery.

Contrary to the prior art recited supra, paint coats that are without runners and abrasion resistant shall be enabled on existing vulcanized silicone gaps and other sealants.

A method for priming silicone surfaces is known from WO 2019 134 817 A1. Thus, a mix of an impregnating agent and a varnish with water or without water is used for priming silicone surfaces wherein the mixture of the components is only produced immediately before application wherein the impregnating agent includes an acid, is free from water and configured as a silicon dioxide precursor that hydrolyses in an acidic environment in the presence of water to form silicone dioxide particles, wherein the varnish is a water thinnable dispersion varnish.

Thus, it is also necessary that the component mixture to be applied is only produced immediately before application. This mix does not include comparable substances like the product according to the invention.

### BRIEF SUMMARY OF THE INVENTION

Thus, is it an object of the invention to overcome the shortcomings of the prior art recited supra.

When using the agent recited supra for priming silicone surfaces the object is achieved according to the invention by an agent that is an emulsion of at least the following components:
a catalyst configured to vulcanize rubber mixes,
an organic solvent or thinner,
glass powder,
a varnish paint forming a carrier substance.

Among the advantages achieved by the invention are: Enabling abrasion resistant coatings without runners of existing vulcanized silicone gaps and other sealants.

The emulsion is compatible with most commercially available paint systems.

The agent according to the invention includes at least four primary components but can also include additional components. The four primary components have the subsequent function:

The first component, the catalyst is used for crosslinking the substance after applying the substance to the silicone surface.

The second component, the organic solvent or thinner, mostly adjusts a desired viscosity.

The third component, the glass powder or glass flour provides adhesion of the primer on the silicone surface.

Alternatively, also tetrapodal tin oxide can be used instead or together with glass powder. More details can be found in the German patent application DE 10 2021 100 113.7 filed on Jan. 6, 2021 which is incorporated herein in its entirety.

The fourth component, the carrier substance, namely the varnish paint facilitates or improves the adhesion of the subsequent coat on the applied and cured primer.

According to the invention, the following are useable as component 1 (catalyst) that has the function of a crosslinker in the system:

In particular, a vulcanization component is well suited for producing a technical silicone rubber.

The products TFC silicone rubber type 2-1 manufactured by Trollfactory, and Replisil 35 NO component B, manufactured by Siliconic are advantageously useable.

Advantageously the following is useable as component 2 (organic solvent or thinner): a white spirit or benzine, e.g., Shellsol® D60 by Shell is advantageously useable. Optionally, the products D40, D100, D120, D140, D160 made by Shell are useable as well.

Optionally, an oil from the group turpentine oil—balm and/or linseed oil and/or natural oils, and/or mineral oils shall be used. Advantageously also the products turpentine oil balm and/or linseed oil and/or natural oils or mineral oils can be used.

Advantageously, the products turpentine or owatrol oil are useable. Owatrol oil is a highly penetrating, air drying oil which can be used by itself or as a paint additive.

Glass powder is advantageously usable as component 3.

Varying the glass powder structure can be used for modifying the surface structure and for adjusting the adhesion properties.

Advantageously the following are useable as component 4 (carrier substance):

A water thinnable dispersion or varnish paint or an acrylic varnish can be advantageously used.

The product “Orgal PR 842A” can be advantageously used which is an acrylate dispersion varnish and/or the product “Plexrtol D487” made by Synthomer, a pure acrylate dispersion.

The inventor has solved the subsequent technical problems and performed an inventive step:
for starters an identification had to be made which varnish carrier enables a substantially stable runner free adhesion on the silicone sealant surface,
in order to further improve adhesion under mechanical impact a substance was to be mixed in which establishes a mechanical interlocking with the surface: the glass powder,
furthermore, it was necessary to add a substance that is chemically similar to the silicone in order to assure compatibility with the silicone surface: the white spirits or benzine.
the catalyst which increases reaction speed by reducing an activation energy that is required for a chemical reaction without being consumed itself. The catalyst accelerates the forward reaction and the backward reaction equally, and thus changes the kinetics of the chemical reactions, but not their thermal dynamics.
the substances recited supra had to be dispersed under vacuum conditions.

Advantageous embodiments of the invention are defined in the dependent claims.

The varnish paint used as the carrier substance advantageously includes 20-70% by weight of a binder from the group including acrylate dispersion varnish, polyurethane, epoxy, an epoxy-based paint binder (e.g., epoxy esta, alkyd, polysiloxane), an acrylic based paint binder (e.g., Lipaton SB 4520 by Synthomer), and/or a pure acrylate dispersion.

Advantageous applications of the novel composition are priming existing silicone gaps at windows, doors, glazing, bathroom installations and engineering applications for subsequent paint systems.

Instead of unsuitable sealants like, e.g., acrylates, high quality sealants like silicone can be used since the product according to the invention provides paintability.

Additional advantageous applications are blocking properties for back coupled influences which prevents softener migration and/or insulates water-, grease-, or soot spots, and color change of products including silicone by painting them over.

### DETAILED DESCRIPTION OF THE INVENTION

Several embodiments of the invention will be described infra.

One application of the product according to the invention is preparing existing silicone gaps at windows, doors, and glazing, in bathroom-, and engineering applications for subsequent paint systems.

An existing apartment block with four floors and 16 apartments shall be painted by a painter with Meier white paint. The apartment block includes 96 windows. The windows have approximately 400 meters of silicone gaps with gray color. The building includes another 150 meters of gray expansion gaps. Thus, the building includes 550 meters of silicone gaps.

The existing silicone gaps cannot be painted with any prior art paint system. Now, the painter has to hire another contractor in order to cut out the existing gaps and renew them so they match the new white paint. The cost of restoring or renewing the gaps is approximately 6000 euros net.

When the painter Meier uses the product according to the invention existing gaps can be painted over. In addition to enormous time savings for matching the color tone of the gaps, the cost is approximately 700 euros net for painting approximately 8 square meters of gaps. The painter Maier and the customer have reduced costs by approximately 90%.

Another embodiment:

A dry wall installer Janssen is contracted to install gypsum dry wall. In order to get the job ready for the painter, the dry wall installer uses a typical acrylic sealant in order to seal the gaps between the ceiling and the wall. The dry wall installer Jannsen, however knows the disadvantages of filling the gaps with acrylic. In recent years the dry wall installer has found for this paintable sealant several times that delamination through over expansion has occurred after months or years and complaints were received from customer.

The reason is that acrylic shrinks is due to high water content and expandability of acrylic sealants which is typically limited to 7%. This technical property causes the problems recited supra.

When the dry wall installer Janssen introduces a higher quality silicone-based sealant into the gaps, the problems of delamination recited supra are eliminated by the higher movement absorption of the silicone (approximately 25% or more).

Since the dry wall installer and the painter subsequently use the product according to the invention, this shows that the product can be used by different trades in several construction phases indoors and outdoors. The higher quality gap sealing reduces complaints, reduces costs, and assures that the customer is happy.

The following composition represents an advantageous example:

| | |
|---|---|
| Catalyst | 7.14% wt. |
| White Spirit | 10% wt. |
| Glass | 7.14% wt. |
| Varnish | 75.72% wt. |

### Production of the Composition According to the Invention

All four components are mixed in a dispersion mixer under vacuum in the ratios recited supra. The composition can be filled into container by machinery.

### Testing of the Composition Recited Supra

Long term testing of painted silicone and sealant surfaces were performed with positive results under European weather conditions.

### Production of the Composition According to the Invention

The following substances were used:
Glass flour/glass powder ST 240 from Reidt GmbH & Co. KG, 52224 Stolberg
Catalyst from the Troll Factory Rainer Habekost e.K., 27339 Riede
Shellsol® D 60 white spirit from Shell
Acrylic varnish from P.A. Jansen GmbH & Co. KG, Bad Neuenahr-Ahrweiler
   Test Results with Compositions According to the Invention

“Oil” according to the invention is an organic solvent or thinner.

| Test 4 | % by weight | Effect | Result |
|---|---|---|---|
| Catalyst | 7.14% | Optimum | Good |
| Oil | 10% | Viscosity | adhesion |
| Glass | 7.14% | | and |
| powder | | | coverage |
| Varnish | 75.2% | | without |
| | | | runners |

75.72% Jansen acrylic varnish
7.14% glass powder/glass flour
10.0% D60 white spirit
7.14% Catalyst (silicone rubber)

### Other Advantageous Recipes

Test Recipe 1:
70.14% Lipaton SB4520 from Symthomer
9.07% glass powder/glass flour
11, 60% D60 white spirit
9.19% Catalyst (silicone rubber)

Test Recipe 2:
76.39% water-based polyurethane varnish
7.14% glass powder/glass flour
10.00% D60 white spirit
6.47% Catalyst (silicone rubber)

Test Recipe 3:
56.6% acrylic varnish, water-based Wilckens
25.157% glass powder/glass flour
7.547% D60 white spirit
5.66% Catalyst (silicone rubber)
5.031% Owatrol

Comparison Tests

| Test 1 | % by weight | Effect | Result |
|---|---|---|---|
| Catalyst | 1.5% | Viscosity | Adhesion |
| Oil | 3% | too high | too low, |
| Glass | 5% | | slight |
| powder | | | runners |
| Varnish | 90.5% | | |

| Test 2 | % by weight | Effect | Result |
|---|---|---|---|
| Catalyst | 1.5% | viscosity | watery |
| Oil | 20% | too low | solution, |
| Glass | 7% | | pronounced |
| powder | | | runners |
| Varnish | 71.5% | | |

| Test 3 | % by weight | Effect | Result |
|---|---|---|---|
| Catalyst | 1.5% | desired | surface |
| Oil | 10% | viscosity | too rough, |
| Glass | 9% | | no runners |
| powder | | | |
| Varnish | 79.5% | | |

1. An agent for priming silicon surfaces, comprising:
an emulsion including:
a catalyst configured to vulcanize rubber mixes,
an organic solvent or thinner,
a fine particle solid material configured as a thickener and adhesion enhancer, and
a varnish paint forming a carrier substance.

2. The agent for priming the silicon surfaces according to claim 1, wherein
the catalyst configured to vulcanize the rubber mixes is configured as a catalyst configured to vulcanize silicone rubber.

3. The agent for priming the silicone surfaces according to claim 1, wherein the organic solvent or thinner is white spirit.

4. The agent for priming the silicone surfaces according to claim 1, wherein
the organic solvent or thinner is an oil from the group consisting of turpentine oil balm, linseed oil, cold pressed linseed oil, natural oil, rapeseed oil, mineral oil or almond oil.

5. The agent for priming the silicone surfaces according to claim 1, wherein
the fine particle solid material is configured as glass powder and/or tetrapodal zinc oxide.

6. The agent for priming the silicone surfaces according to claim 1, wherein
the varnish paint is water thinnable dispersion varnish paint, a varnish paint including solvent, an acrylic varnish paint, a PU-varnish, a water based polyurethane varnish or an acrylic water varnish.

7. The agent for priming the silicon surfaces according to claim 1,
wherein the fine particle solid material is glass powder and/or tetrapodal zinc oxide,
wherein the catalyst is 3 to 10 percent by weight,
wherein the organic solvent or thinner is 5 to 20% by weight,
the fine particle solid material is 4 to 40% by weight, and
wherein the varnish paint is 50 to 80% by weight.

8. The agent for priming the silicon surfaces according to claim 1,
wherein the catalyst is 6 to 9% by weight,
wherein the organic solvent or thinner is 5 to 15% by weight,
wherein the glass powder is 5 to 8% by weight, and
wherein the varnish paint is the rest.

9. The agent for priming the silicon surfaces according to claim 1, wherein
the agent includes polyvinyl pyrrolidone.

10. The use of the agent for priming the silicon surfaces according to claim 1, wherein
the agent includes titanium dioxide or food starch or flour.

11. The agent for priming the silicon surfaces according to claim 1, wherein the varnish paint used for the carrier substance includes 20 to 70% by weight of a binder from the group consisting of acrylate dispersion varnish, polyurethane, epoxy, epoxy-based paint binder, alkyd, polysiloxan, and an acrylic based paint binder, or a pure acrylate dispersion.

12. The agent for priming the silicon surfaces according to claim 2, wherein
the catalyst configured to vulcanize the rubber mixes is configured as a TFZ-silicone-rubber-type-2-1 catalyst, a catalyst for siloxane, or a catalyst for synthetic rubber or natural rubber.
